(19) United States
(12) Patent Application Publication
(10) Pub. No.: US 2014/0340591 A1
(43) Pub. Date: Nov. 20, 2014

(54) MULTIFUNCTION INPUT DEVICE

(71) Applicant: GLOBAL LIGHTING TECHNOLOGIES INC., TAOYUAN HSIEN (TW)

(72) Inventors: CHI-CHUNG CHANG, TAOYUAN COUNTY (TW); FAN-WEI WU, TAOYUAN COUNTY (TW)

(21) Appl. No.: 13/936,371

(22) Filed: Jul. 8, 2013

(30) Foreign Application Priority Data
May 17, 2013 (TW) 102117515

(51) Int. Cl. G06F 3/041

(52) U.S. Cl. CPC G06F 3/041
USPC 349/12

(57) ABSTRACT

A multifunction input device includes a backlight module, a medium layer, a touch panel and a switching unit. The backlight module includes a light-guiding plate, a reflector directly disposed on the bottom surface of the light-guiding plate, and at least one light-emitting element disposed beside the light-guiding plate, and the light-guiding plate has a plurality of light output microstructure blocks matched with each other to form at least one keyboard pattern. The medium layer is directly disposed on the top surface of the light-guiding plate, and the transmittance rate of the medium layer is about 20% to 80%. The touch panel is directly disposed on the medium layer. The switching unit is applied to the touch panel to control the at least one light-emitting element. The medium layer is a single medium layer directly disposed between the light-guiding plate and the touch panel.

### BACKGROUND OF THE INVENTION

1. Field of the Invention

The instant disclosure relates to a multifunction input device, and more particularly to a multifunction input device for providing a plurality of function input modes.

2. Description of Related Art

Touch pad is well known and widely used in various electronic products. Touch pad provides a simple, easy and cheap pointing device, such as those in laptop computer systems for mouse function. The prior art shows a schematic diagram of the construction of a touch pad and the operational principle thereof, in which an insulator plate is arranged on the top of the functional stack consisting of a ground plate, a layer of traces along Y-axis, a layer of traces along X-axis, all of them connected to a control circuit apart from the panel. An equivalent capacitance presents between the Y-axis trace and the ground plate, and an equivalent capacitance presents between the X-axis trace and the ground plate. Once finger or conductor touching the panel, the control circuit determines the touched position of the finger or conductor by sensing the change in capacitances of each corresponding traces and responds for further process.

### SUMMARY OF THE INVENTION

One aspect of the instant disclosure relates to a multifunction input device for providing a plurality of function input modes.

One of the embodiments of the instant disclosure provides a multifunction input device, comprising a backlight module, a medium layer, a touch panel and a switching unit. The backlight module includes a light-guiding plate, a reflector directly disposed on the bottom surface of the light-guiding plate, and at least one light-emitting element disposed beside the light-guiding plate, and the light-guiding plate has a plurality of light output microstructure blocks matched with each other to form at least one keyboard pattern. The medium layer is directly disposed on the top surface of the light-guiding plate, and the transmittance rate of the medium layer is about 20% to 80%. The touch panel is directly disposed on the medium layer. The switching unit is applied to the touch panel to control the at least one light-emitting element. In addition, the medium layer is a single medium layer directly disposed between the light-guiding plate and the touch panel. Whereby, when the at least one light-emitting element has been turned on to illuminate the light-guiding plate, the at least one keyboard pattern is illuminated by the at least one light-emitting element to distinctly form a light embossment pattern on the touch panel for providing a first function input mode. When the at least one light-emitting element has not been turned on yet to illuminate the light-guiding plate, the at least one keyboard pattern is shaded from ambient lights by the medium layer to form a dark screen on the touch panel for providing a second function input mode.

Another one of the embodiments of the instant disclosure provides a multifunction input device, comprising a backlight module, a light-shielding layer, a touch panel and a switching unit. The backlight module includes a light-guiding plate, a reflector directly disposed on the bottom surface of the light-guiding plate, and at least one light-emitting element disposed beside the light-guiding plate, wherein the light-guiding plate has a plurality of light output microstructure blocks. The light-shielding layer is directly disposed on the top surface of the light-guiding plate, and the light-shielding layer has a plurality of hollow intaglios respectively corresponding to the light output microstructure blocks. The touch panel is directly disposed on the light-shielding layer. The switching unit is applied to the touch panel to control the at least one light-emitting element. Whereby, when the at least one light-emitting element has been turned on to illuminate the light-guiding plate, the hollow intaglios are illuminated by the at least one light-emitting element to distinctly form a light embossment pattern on the touch panel for providing a first function input mode. When the at least one light-emitting element has not been turned on yet to illuminate the light-guiding plate, the hollow intaglios are shaded from ambient lights by the light-shielding layer to form a dark screen on the touch panel for providing a second function input mode.

Therefore, because “the transmittance rate of the medium layer is about 20% to 80%, and the medium layer can be directly disposed between the light-guiding plate and the touch panel” and/or “the light-shielding layer having a plurality of hollow intaglios can be directly disposed between the light-guiding plate and the touch panel”, thus the multifunction input device of the instant disclosure provides a plurality of function input modes on the same input device for the user.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows a lateral, schematic view of the multifunction input device (when turning off the light-emitting element) according to the first embodiment of the instant disclosure;

FIG. 2 shows a function block of the touch panel and the switching unit of the multifunction input device according to the first embodiment of the instant disclosure;

FIG. 3 shows a flowchart of the method of using the multifunction input device (when turning off the light-emitting element) according to the first embodiment of the instant disclosure;

FIG. 4 shows a lateral, schematic view of the multifunction input device (when turning on the light-emitting element) according to the first embodiment of the instant disclosure;

FIG. 5 shows a flowchart of the method of using the multifunction input device (when turning on the light-emitting element) according to the first embodiment of the instant disclosure;

FIG. 6 shows a lateral, schematic view of the multifunction input device according to the second embodiment of the instant disclosure;

FIG. 7 shows a lateral, schematic view of the multifunction input device according to the third embodiment of the instant disclosure; and

FIG. 8 shows a lateral, schematic view of the multifunction input device according to the fourth embodiment of the instant disclosure.

### DETAILED DESCRIPTION OF THE PREFERRED EMBODIMENTS

### First Embodiment

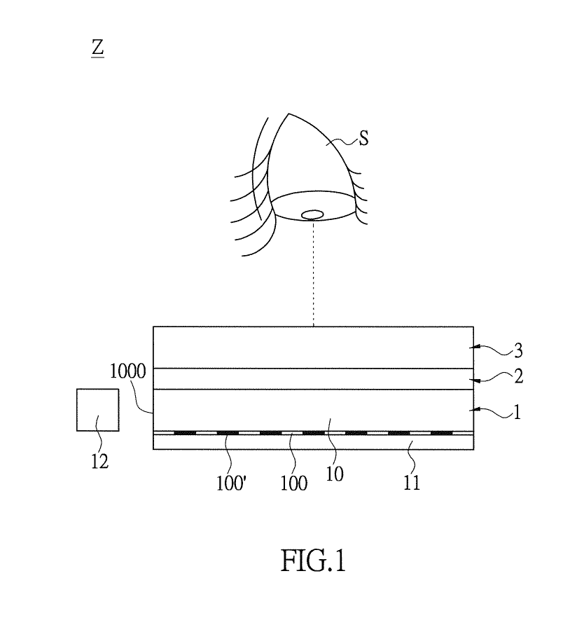

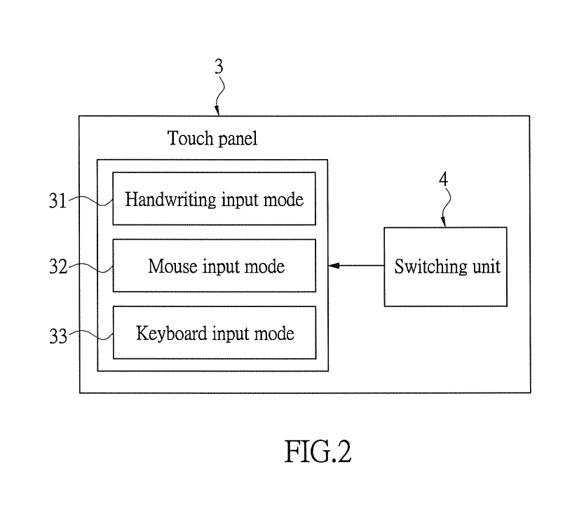

Referring to FIG. 1 and FIG. 2, where the first embodiment of the instant disclosure provides a multifunction input device Z, comprising: a backlight module 1, a medium layer 2, a touch panel 3 and a switching unit 4.

First, referring to FIG. 1, the backlight module 1 includes a light-guiding plate 10, a reflector 11 directly disposed on the bottom surface of the light-guiding plate 10, and at least one light-emitting element 12 disposed beside the light-guiding plate 10 and adjacent to the lateral side 1000 of the light-guiding plate 10. In addition, the light-guiding plate 10 has a plurality of light output microstructure blocks 100′ matched with each other to form at least one keyboard pattern 100, and the at least one keyboard pattern 100 is disposed on the bottom surface of the light-guiding plate 10 and between the light-guiding plate 10 and the reflector 11. The light-guiding plate 10 can be made by transparent materials such as PS and PMMA. The reflector 11 has a white or silver reflecting layer coated or printed on the surface of the reflector 11 for increasing the reflection effect, and the reflector 11 is directly attached to the bottom surface of the light-guiding plate 10 via adhesive materials such as the optically clear adhesive (OCA). The at least one light-emitting element 12 can be achieved by a LED light bar for generating a white light source. The at least one keyboard pattern 100 is formed on the bottom surface of the light-guiding plate 10 in advance by coating, printing or etching etc. However, the above-mentioned design for the light-guiding plate 10, the reflector 11 and the light-emitting element 12 of the first embodiment is merely an example and is not meant to limit the instant disclosure.

Moreover, referring to FIG. 1, the medium layer 2 is directly disposed on the top surface of the light-guiding plate 10. The transmittance rate of the medium layer 2 is between about 20% and 80%, and the medium layer 2 is purely a single medium layer (not a modularization multilayer structure layer) directly disposed between the light-guiding plate 10 and the touch panel 3. For example, the medium layer 2 may be an infrared ink (IR ink) layer or a polarization film. More precisely, the infrared ink layer allows the near infrared light source having 780˜1200 nm wavelength to pass through itself, but the visible light source having 380˜780 nm wavelength (it is less than the near infrared light source) and the ultraviolet light source are shaded by the infrared ink layer.

Furthermore, referring to FIG. 1 and FIG. 2, the touch panel 3 is directly disposed on the medium layer 2, and the switching unit 4 is applied to the touch panel 3 to control the light-emitting element 12. More precisely, the reflector 11, the light-guiding plate 10, the medium layer 2 and the touch panel 3 are sequentially stacked on top of one another from bottom to top, thus the reflector 11, the light-guiding plate 10, the medium layer 2 and the touch panel 3 are tightly connected with each other without forming any gaps between any two adjacent layers. In addition, the touch panel 3 can provide a handwriting input mode 31, a mouse input mode 32 and a keyboard input mode 33, and the touch panel 3 can be switched to the handwriting input mode 31, the mouse input mode 32 or the keyboard input mode 33 through the switching unit 4. In other words, the user can use the switching unit 4 to switch the touch panel 3 to the handwriting input mode 31, the mouse input mode 32 or the keyboard input mode 33 according to different requirements. For example, the switching unit 4 may be software or firmware in the multifunction input device Z, or the switching unit 4 may be a touch icon regarded as a user touch interface on a touch screen of the touch panel 3.

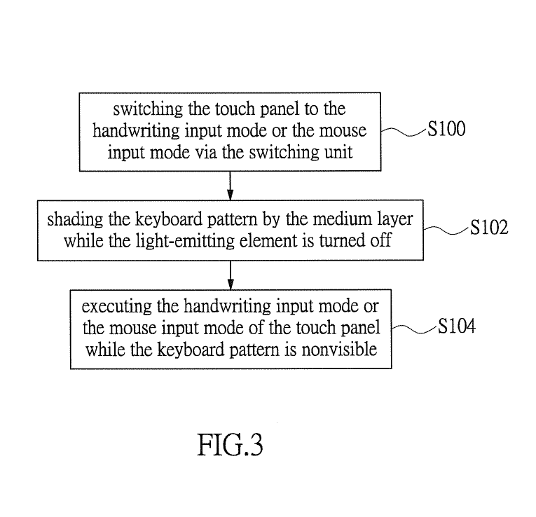

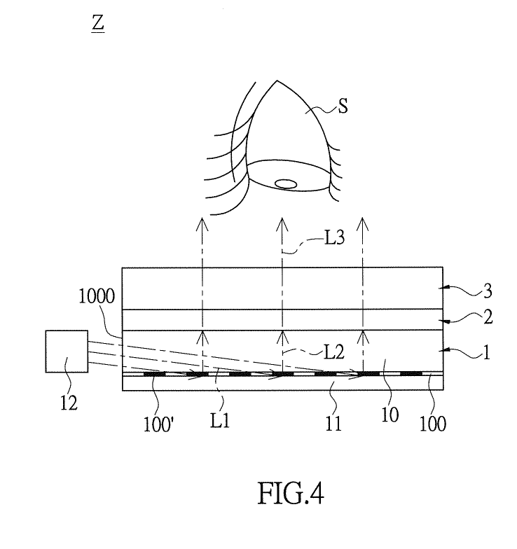

Besides, referring to FIG. 1 and FIG. 3, where the first embodiment of the instant disclosure can also provide a method of using a multifunction input device Z, comprising the steps of: first, switching the touch panel 3 from the keyboard input mode 33 to the handwriting input mode 31 or the mouse input mode 32 through the switching unit 4 (S100); next, shading the at least one keyboard pattern 100 by the medium layer 2 while the at least one light-emitting element 12 is turned off (S102), whereby the at least one keyboard pattern 100 is not illuminated by the at least one light-emitting element 12 and the keyboard pattern 100 is nonvisible by the user S; then, executing the handwriting input mode 31 or the mouse input mode 32 of the touch panel 3 while the keyboard pattern 100 is nonvisible (S104). In other words, when the touch panel 3 is switched from the keyboard input mode 33 to the handwriting input mode 31 or the mouse input mode 32 through the switching unit 4, the at least one light-emitting element 12 is turned off and cannot generate input light beams L1 (as shown in FIG. 4). This moment, the at least one keyboard pattern 100 cannot be illuminated by the at least one light-emitting element 12 and is shaded from ambient lights by the medium layer 2, thus the user S can use the handwriting input mode 31 or the mouse input mode 32 of the touch panel 3 without watching the at least one keyboard pattern 100 that cannot be illuminated by the at least one light-emitting element 12 and is shaded from ambient lights by the medium layer 2. More precisely, when the touch panel 3 is switched to the handwriting input mode 31 or the mouse input mode 32 through the switching unit 4, the touch screen of the touch panel 3 is shown as a dark screen, thus it is convenient for the user S to execute the handwriting input mode 31 or the mouse input mode 32 of the touch panel 3.

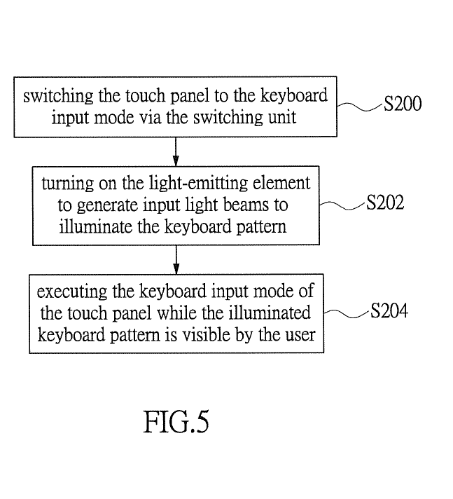

In addition, referring to FIG. 4 and FIG. 5, where the first embodiment of the instant disclosure can also provide a method of using a multifunction input device Z, comprising the steps of: first, switching the touch panel 3 from the handwriting input mode 31 or the mouse input mode 32 to the keyboard input mode 33 via the switching unit 4 (S200); next, turning on the at least one light-emitting element 12 to generate input light beams L1 to illuminate the at least one keyboard pattern 100 (S202), whereby the input light beams L1 generated by the at least one light-emitting element 12 can be projected into the light-guiding plate 10 through the lateral side 1000; then, executing the keyboard input mode 33 of the touch panel 3 while the illuminated keyboard pattern 100 is visible by the user S (S204). In other words, when the touch panel 3 is switched from the handwriting input mode 31 or the mouse input mode 32 to the keyboard input mode 33 through the switching unit 4, the at least one light-emitting element 12 is turned on for generating input light beams L1 (as shown in FIG. 4). This moment, the input light beams L1 generated by the at least one light-emitting element 12 can be projected into the light-guiding plate 10 through the lateral side 1000 to illuminate the at least one keyboard pattern 100, thus the keyboard pattern 100 is visible by the user S, the keyboard input mode 33 of the touch panel 3 is enabled, and the handwriting input mode 31 or the mouse input mode 32 is disabled.

Therefore, when the at least one light-emitting element 12 has been turned on to illuminate the light-guiding plate 10, the at least one keyboard pattern 100 is illuminated by the at least one light-emitting element 12 to distinctly and recognizably form a light embossment pattern on the touch panel 3 (i.e., the illuminated keyboard pattern 100 looks like to be shown on the touch panel 3) for providing a first function input mode (i.e., the keyboard input mode 33) for the user S, thus the user S can use the keyboard input mode 33 on the touch panel 3. When the at least one light-emitting element 12 is not turned on to illuminate the light-guiding plate 10, the at least one keyboard pattern 100 is shaded from ambient lights by the medium layer 2 to form a dark screen on the touch panel 3 for providing a second function input mode (i.e., the handwriting input mode 31 or the mouse input mode 32) for the user S.

### Second Embodiment

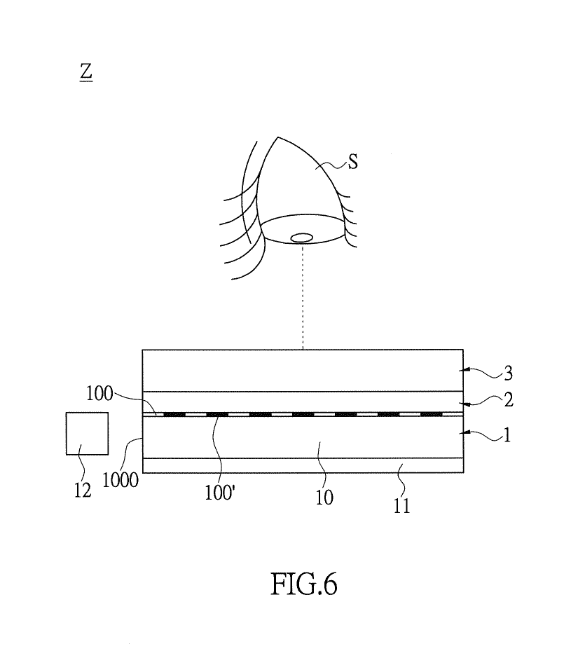

Referring to FIG. 6, where the second embodiment of the instant disclosure provides a multifunction input device Z, comprising: a backlight module 1, a medium layer 2, a touch panel 3 and a switching unit (not shown). Comparing FIG. 6 with FIG. 1, the difference between the second embodiment and the first embodiment is as follows: in the second embodiment as shown in FIG. 6, the at least one keyboard pattern 100 also can be disposed on the top surface of the light-guiding plate 10 and between the light-guiding plate 10 and the medium layer 2. Hence, according to different requirements, the at least one keyboard pattern 100 can be disposed on the bottom surface of the light-guiding plate 10 and between the light-guiding plate 10 and the reflector 11 (as shown in FIG. 1 of the first embodiment), or the at least one keyboard pattern 100 can be disposed on the top surface of the light-guiding plate 10 and between the light-guiding plate 10 and the medium layer 2 (as shown in FIG. 6 of the second embodiment).

### Third Embodiment

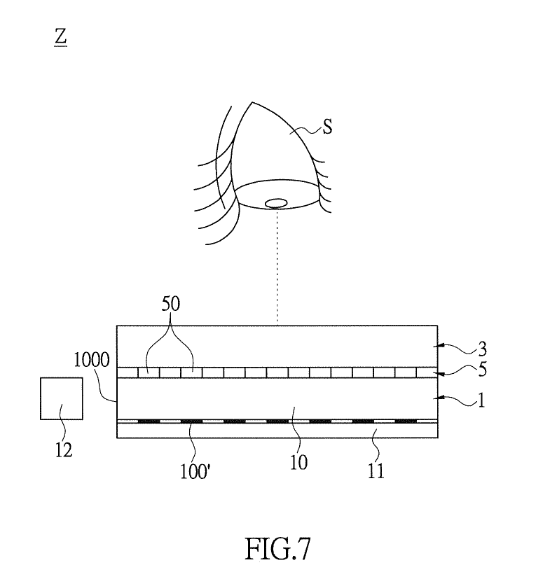

Referring to FIG. 7, where the third embodiment of the instant disclosure provides a multifunction input device Z, comprising: a backlight module 1, a light-shielding layer 5, a touch panel 3 and a switching unit (not shown). Comparing FIG. 7 with FIG. 1, the difference between the third embodiment and the first embodiment is as follows: in the third embodiment as shown in FIG. 7, the light-shielding layer 5 is directly disposed on the top surface of the light-guiding plate 10, the touch panel 3 is directly disposed on the light-shielding layer 5, and the light-shielding layer 5 has a plurality of hollow intaglios 50 respectively corresponding to the light output microstructure blocks 100′. For example, the light-shielding layer 5 may be an infrared ink layer.

Whereby, when the at least one light-emitting element 12 has been turned on to illuminate the light-guiding plate 10, the hollow intaglios 50 are illuminated by the at least one light-emitting element 12 to distinctly and recognizably form a light embossment pattern on the touch panel 3 (i.e., the illuminated keyboard pattern 100 is appeared on the touch panel 3) for providing a first function input mode (i.e., the keyboard input mode 33) for the user S. When the at least one light-emitting element 12 is not turned on to illuminate the light-guiding plate 10, the hollow intaglios 50 are shaded from ambient lights by the light-shielding layer 5 to form a dark screen on the touch panel 3 for providing a second function input mode for the user S.

### Fourth Embodiment

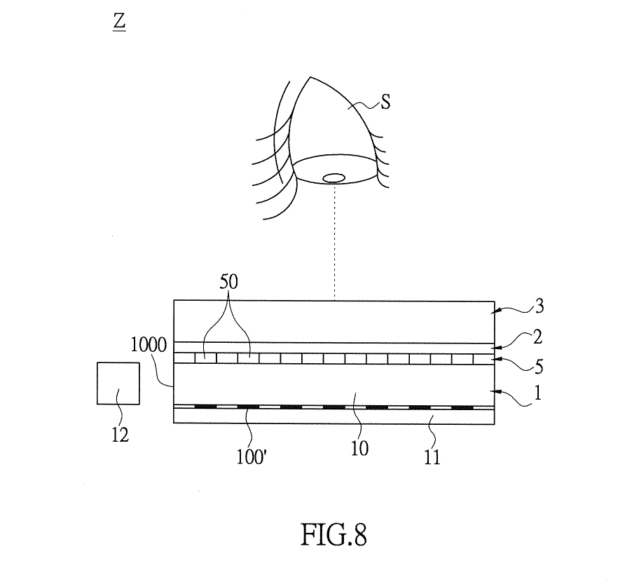

Referring to FIG. 8, the fourth embodiment of the instant disclosure provides a multifunction input device Z, comprising: a backlight module 1, a medium layer 2, a light-shielding layer 5, a touch panel 3 and a switching unit (not shown). Comparing FIG. 8 with FIG. 7, the difference between the fourth embodiment and the third embodiment is as follows: in the fourth embodiment as shown in FIG. 8, the medium layer 2 can be disposed between the light-shielding layer 5 and the touch panel 3 to cover the hollow intaglios 50, and the transmittance rate of the medium layer 2 is between about 20% and 80%. Hence, according to different requirements, the instant disclosure can merely has the light-shielding layer 5 (such as a single layer) between the light-guiding plate 10 and the touch panel 3 (as shown in FIG. 7 of the third embodiment), or has a multilayer layer composed by the medium layer 2 and the light-shielding layer 5, and located between the light-guiding plate 10 and the touch panel 3 (as shown in FIG. 8 of the fourth embodiment).

In conclusion, because “the transmittance rate of the medium layer 2 is between about 20% and 80%, and the medium layer 2 is directly disposed between the light-guiding plate 10 and the touch panel 3” and/or “the light-shielding layer 5 having a plurality of hollow intaglios 50 can be directly disposed between the light-guiding plate 10 and the touch panel 3”, thus the instant disclosure provides a plurality of function input modes on the same input device Z for the user.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A multifunction input device, comprising:
a backlight module including a light-guiding plate, a reflector directly disposed on the bottom surface of the light-guiding plate, and at least one light-emitting element disposed beside the light-guiding plate, wherein the light-guiding plate has a plurality of light output microstructure blocks matched with each other to form at least one keyboard pattern;
a medium layer directly disposed on the top surface of the light-guiding plate, wherein the transmittance rate of the medium layer is 20% to 80%;
a touch panel directly disposed on the medium layer; and
a switching unit applied to the touch panel to control the at least one light-emitting element.

2. The multifunction input device of claim 1, wherein the medium layer is a single medium layer directly disposed between the light-guiding plate and the touch panel.

3. The multifunction input device of claim 2, wherein the at least one keyboard pattern is illuminated by the at least one light-emitting element to distinctly form a light embossment pattern on the touch panel for providing a first function input mode when the at least one light-emitting element is turned on to illuminate the light-guiding plate.

4. The multifunction input device of claim 3, wherein the at least one keyboard pattern is shaded from ambient lights by the medium layer to form a dark screen on the touch panel for providing a second function input mode when the at least one light-emitting element is turned off.

5. The multifunction input device of claim 4, wherein the first function input mode is a keyboard input mode, and the second function input mode is a handwriting input mode.

6. The multifunction input device of claim 4, wherein the first function input mode is a keyboard input mode, and the second function input mode is a mouse input mode.

7. The multifunction input device of claim 1, wherein the switching unit is a touch icon regarded as a user touch interface on a touch screen of the touch panel.

8. The multifunction input device of claim 1, wherein the medium layer is an infrared ink layer.

9. The multifunction input device of claim 1, wherein the medium layer is a polarization film.

10. A multifunction input device, comprising:
a backlight module including a light-guiding plate, a reflector directly disposed on the bottom surface of the light-guiding plate, and at least one light-emitting element disposed beside the light-guiding plate, wherein the light-guiding plate has a plurality of light output microstructure blocks;
a light-shielding layer directly disposed on the top surface of the light-guiding plate, wherein the light-shielding layer has a plurality of hollow intaglios respectively corresponding to the light output microstructure blocks;
a touch panel directly disposed on the light-shielding layer; and
a switching unit applied to the touch panel to control the at least one light-emitting element.

11. The multifunction input device of claim 10, wherein the light-shielding layer is an infrared ink layer.

12. The multifunction input device of claim 10, further comprising a medium layer disposed between the light-shielding layer and the touch panel to cover the hollow intaglios, and the transmittance rate of the medium layer is 20% to 80%.

13. The multifunction input device of claim 12, wherein the medium layer is an infrared ink layer.

14. The multifunction input device of claim 12, wherein the medium layer is a polarization film.

15. The multifunction input device of claim 10, wherein the hollow intaglios are illuminated by the at least one light-emitting element to distinctly form a light embossment pattern on the touch panel for providing a first function input mode when the at least one light-emitting element is turned on to illuminate the light-guiding plate.

16. The multifunction input device of claim 15, wherein the hollow intaglios are shaded from ambient lights by the light-shielding layer to form a dark screen on the touch panel for providing a second function input mode when the at least one light-emitting element is turned off.

17. The multifunction input device of claim 16, wherein the first function input mode is a keyboard input mode, and the second function input mode is a handwriting input mode.

18. The multifunction input device of claim 16, wherein the first function input mode is a keyboard input mode, and the second function input mode is a mouse input mode.

19. The multifunction input device of claim 10, wherein the switching unit is a touch icon regarded as a user touch interface on a touch screen of the touch panel.
